(19) United States
(12) Patent Application Publication
(10) Pub. No.: US 2010/0126240 A1
(43) Pub. Date: May 27, 2010

(54) DEVICE FOR LOCKING A LOCK

(75) Inventor: Reinhard Pöllabauer, Vienna (AT)

Correspondence Address: CHAPMAN AND CUTLER, 111 WEST MONROE STREET, CHICAGO, IL, 60603, US

(73) Assignee: EVVA Sicherheitstechnologie GmbH, Vienna (AT)

(21) Appl. No.: 12/451,945

(22) PCT Filed: Jun. 5, 2008
(86) PCT No.: PCT/AT2008/000195

§ 371 Date: Dec. 8, 2009

(30) Foreign Application Priority Data
Jun. 19, 2007 (AT) A 951/2007

(51) Int. Cl. E05B 47/00

(52) U.S. Cl. 70/277

(57) ABSTRACT

In a device for locking a lock, in which an actuating member (6) can be coupled with a locking device, such as a locking lug (2), via an interposed coupling device, the coupling device comprises a driver element (7, 7′, 7″, 15, 25, 30, 30′, 36, 36′) and an actuator (8, 8′, 8″, 16, 24, 31, 31′, 38, 38′) made of an electroactive polymer, wherein the driver element (7, 7′, 7″, 15, 25, 30, 30′, 36, 36′) is movable between an engagement position and a disengagement position by the aid of the actuator (8, 8′, 8″, 16, 24, 31, 31′, 38, 38′).

The invention relates to a device for locking a lock, in which an actuating member can be coupled with a locking device, such as a locking lug, via an interposed coupling device.

Locking-engineering devices known so far are usually mechanical or electronic devices. Above all, mechanical devices such as all types of door locks, padlocks or the like have been known for a long time. The advantage of those constructions is their simple and cheap production using technologies known for long. A substantial disadvantage, however, is the sometimes insufficient security of such locks against forbidden picking.

An enhanced protection against any unauthorized access is provided by electronic locking devices, since such locks comprise encoded locking information and cannot be counterfeited by known technologies. As a rule, it is, however, disadvantageous that such locking-engineering devices call for complex electronic and mechanical components for activating the locking elements, thus involving high energy consumption. Due to the usually elaborate structures of such electronic locking devices, those constructions are expensive to produce and, on account of the great number of components, also frequently prone to failure.

For locking a lock, an actuating member such as a door handle, a door knob, a key or the like is usually provided, whose movement is coupled with the locking device, such as a locking lug or a locking bar, either directly or via an interposed coupling device for opening or closing the lock, said coupling device usually coupling the actuating member with the locking device only if an access authorization has been detected. Such an access authorization can be detected either mechanically by the insertion of a suitable key or electronically through identification with an electronic code. Conventional coupling devices are complex in structure and prone to maintenance, particularly with electronic keys, since the coupling members in most cases have to be driven by motors for movement between an engagement position and a disengagement position.

EP 1 516 983 A1 describes a locking cylinder which comprises a driving means including a piezoelectric element for driving a locking bar. Upon energization of the piezoelectric element, the locking bar is moved from a position locking the locking cylinder into an unlocking position and vice versa.

US 2005/0210874 A1 describes and shows a locking mechanism using an electroactive polymer to keep a locking member in an engagement position and a disengagement position, respectively.

The present invention' aims to avoid the above-mentioned disadvantages and provide a locking device which is cheap to produce and less prone to maintenance while offering an enhanced locking security.

To this end, the invention is essentially characterized in that the coupling device comprises a driver element and an actuator made of an electroactive polymer, wherein the driver element is movable between an engagement position and a disengagement position by the aid of the actuator. The fact that the driver element responsible for the coupling of the actuating member with the locking device is comprised of an actuator made of an electroactive polymer and movable between an uncoupled and a coupled position, enables the simple activation of the driver element, motors plus the required gears and the like thus being obviated.

Electroactive polymers have already become known in various configurations. Electroactive polymers convert electric energy into mechanical work. Electroactive polymers, in particular, change their shapes and dimensions upon application of an electric voltage. The advantage of electroactive polymers, in particular, resides in the fact that, unlike conventional actuators, they are able to undergo large deformations and dimensional changes while, at the same time, exerting large forces. Due to their comparability with biological tissues, particularly in terms of the achievable expansion and the achievable forces, electroactive polymers are frequently denoted as “artificial muscles”.

Basically, distinction is made between two different types of electroactive polymers. With dielectric electroactive polymers, the activation is effected by electrostatic forces between two electrodes, between which the polymer is held. The activation requires very high voltages in the order of some thousand volts, yet the current consumption is very low. Examples of dielectric electroactive polymers include electrostrictive polymers and dielectric elastomers.

With ionic electroactive polymers, the activation is effected by the displacement of ions within the polymer. For the activation, a voltage of only a few volts will do, yet the displacement of ions requires a relatively high electric current. The electroactive polymer resumes its original shape as soon as the activation current is turned off again. The group of ionic electroactive polymers includes conductive polymers, ionic metal polymer composites and ionic gels.

In the context of the present invention, the above-described properties of electroactive polymers can be utilized in various ways. According to a preferred configuration, the actuator can be devised such that it will change its dimension upon application of an electric voltage. The longitudinal change may, for instance, be directly passed on to the drive element, which is translationally guided. The driver element can be moved between an engagement position and a disengagement position by performing a translational movement. In this respect, it is preferably provided that the driver element is translationally guided in a direction parallel with the axis of rotation of the actuating member.

According to a preferred configuration, the driver element can be pivotally mounted. The driver element in this case may, for instance, be formed as a lever which is mounted so as to rotate about a central or eccentric pivot axis. The actuator may contact one of the lever arms of the actuator to move the other lever arm between an engagement position and a disengagement position. An accordingly eccentric arrangement of the pivot axis may generate a lever action such that small dimensional changes of the electroactive polymer will be translated into accordingly large movements of the driver element.

According to a modified embodiment, the actuator may be devised such that it will bend or arch upon application of an electric voltage. In a configuration in which the actuator is bent upon application of an electric voltage, the bending end itself may be designed as a driver element and assume an engagement position in one of its bent positions and a disengagement position in the other of its two bent positions.

According to a preferred configuration, the driver element is formed by the surface of an electroactive textural polymer or ionic electroactive polymer. With such an electroactive polymer, the surface structure can be modified upon application of a voltage so as to cause a frictional engagement with a counter-element. In this case, the coupling device is thus a friction coupling.

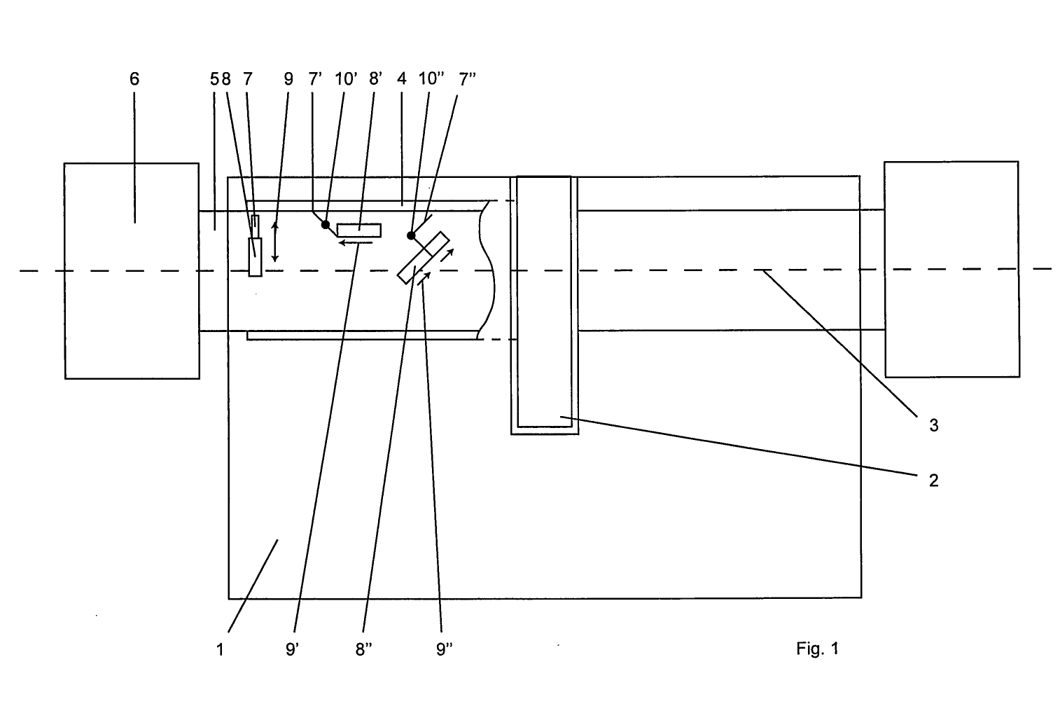

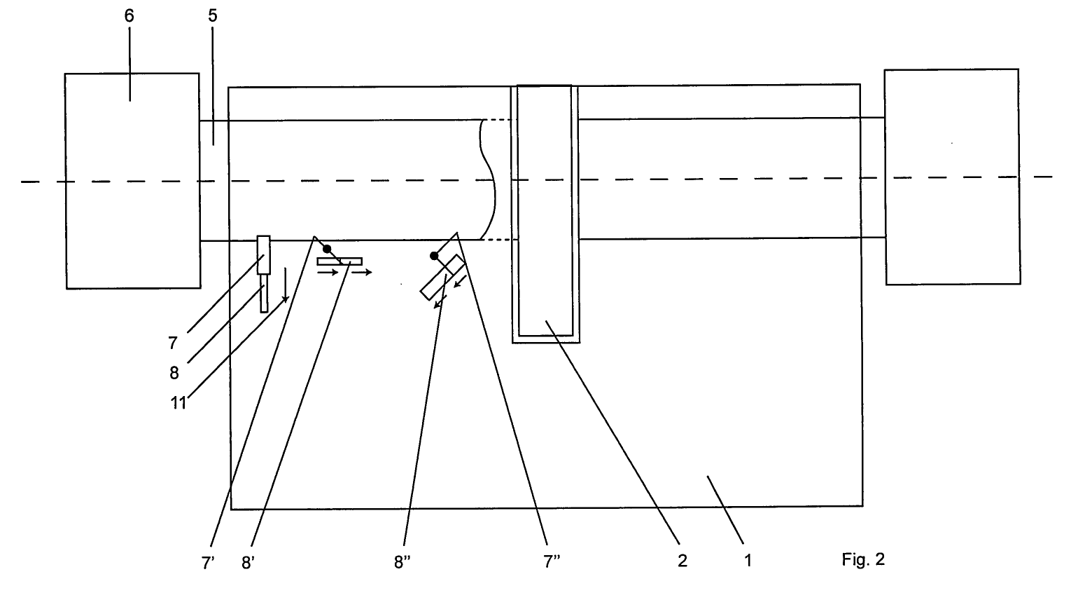

In the following, the invention will be explained in more detail by way of an exemplary embodiment schematically illustrated in the drawing. Therein, FIG. 1 depicts the device according to the invention for locking a lock in a first configuration, and FIGS. 2 to 9 illustrate further configurations. FIG. 1 depicts a locking cylinder, whose locking lug is denoted by 2. The locking lug is connected in a rotationally fast manner with a tube 4 mounted within the cylinder 1 so as to be rotatable about an axis 3. A pin 5 carrying an actuating member such as, for instance, an actuating knob 6 is mounted within the tube 4. The actuating member 6 is connected with the locking lug 2 via an interposed coupling device, said coupling device being formed by the tube 4 and the pin 5 mounted within the tube 4. The coupling device comprises a conventional drive element 7 made of a material preferably containing no electroactive polymer, wherein the driver element is movable between an engagement position and a disengagement position in the sense of double arrow 9 by the aid of an actuator 8. In the position illustrated in FIG. 1, the driver element 7 is in the disengagement position so as to enable the pin 5 to freely rotate within the tube 4 in a manner that a rotation of the knob 6 will remain ineffective and, in particular, not cause any activation of the locking lug 2. After having applied a voltage or current to the actuator 8 comprising an electroactive polymer, a dimensional change of the actuator causes a displacement of the driver element 7 and an engagement of the driver element 7 in a recess of the tube 4 (not illustrated), thus causing the actuating knob 6 to be coupled with the locking lug 2.

In addition to the arrangements of the driver element and the actuator, which are respectively denoted by reference numerals 7 and 8 in FIG. 1, alternative arrangements are illustrated. In a first alternative configuration, the actuator 8′ is vertically arranged and, at a dimensional change in the sense of arrow 9′, causes the driver element 7′ designed as a lever to pivot about the axis 10′, whereby, due to such a pivotal movement, the end of the driver element 7′ facing away from the actuator 8′ will be pivoted in the direction of the tube 4 with the driver element 7′ engaging the tube 4.

In a further alternative configuration, an actuator 8″ is provided, which, at a dimensional change in the sense of arrow 9″, will act on a driver element 7″ designed as a lever, which will in turn be pivoted about an axis 10″ in order to reach an engagement position.

The actuators depicted in FIG. 1 are made of electroactive polymers expanding in the longitudinal direction, or being compressed in the transverse direction, upon application of a voltage. In principle, it is, however, also possible to use actuators which are designed as membranes and which will arch into a predetermined direction upon application of a voltage. The actuator may also comprise an electroactive polymer which will bend upon application of a voltage, thus moving, for instance, a metal pin. Electroactive polymers may include those which retain their changed dimensions when the activation voltage is turned off, or those which resume their original dimensions when the activation voltage is turned off. In a configuration according to FIG. 1, the use of electroactive polymers resuming their original shapes after having turned off the activation voltage will ensure that an actuation of the locking member will only be possible in the activated state of the actuator. After having turned off the activation voltage, the actuator will resume its original dimension such that the driver element will be moved into its original position of disengagement, while an actuation of the locking member will be prevented, since the actuating knob 6 as well as the pin 5 will only spin freely without any effect.

By contrast, the actuating knob 6 in the modified configuration according to FIG. 2 is blocked in the non-released state of the locking member. In this state, the pin 5 is permanently connected in a rotationally fast manner with the ring comprising the locking lug 2, a rotation of the actuating knob 6 in the position illustrated in FIG. 2 being blocked in that the driver element 7, which is displaceably guided within the locking cylinder 1, engages a recess of the pin 5. It is only by the application of voltage to the actuator 8, that the latter will be shortened in the sense of arrow 11 so as to allow the driver element 7 to disengage and render the pin freely movable again. Alternative configurations including tiltable driver elements 7′ and 7″ are likewise illustrated as alternatives in FIG. 2. As an actuating element, the actuating knob 6 may also be replaced with a locking cylinder having a key function either one side or on both sides.

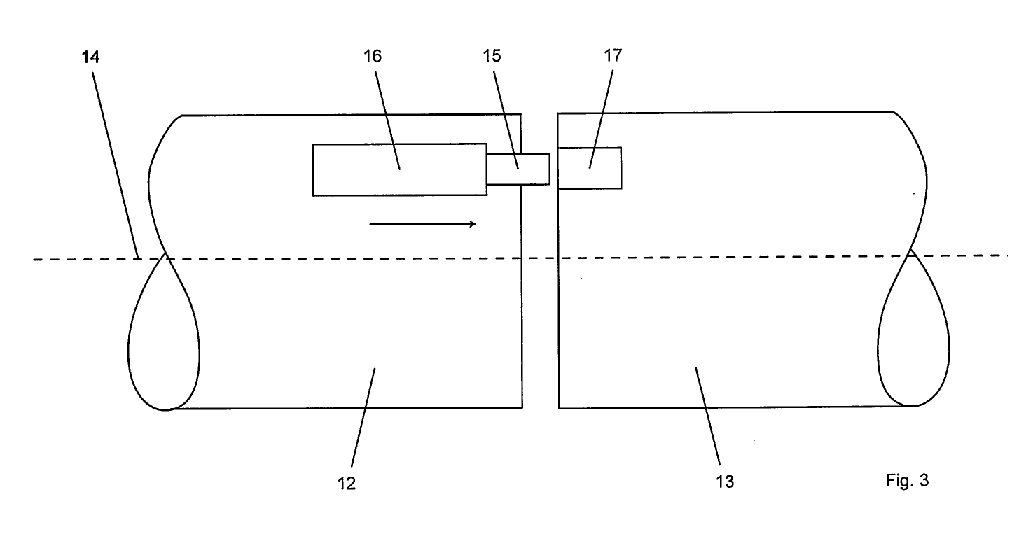

In the configuration according to FIG. 3, the coupling device is comprised of two alignedly arranged pins 12 and 13, the pin being, for instance, connected or coupled with the actuating element and the pin 13 being, for instance, connected or coupled with the locking device, e.g. the locking lug. The axis of rotation of the pins 12 and 13 is denoted by 14, wherein a driver element 15 is translationally guided in parallel with the axis of rotation 14, said driver element 15 being movable between an engagement position and a disengagement position by the aid of an actuator 16 made of an electroactive polymer. In the engagement position, the driver element 15 comes to rest in an appropriate recess 17 of the pin 13 so as to provide both a positive connection between the pins 12 and 13 and a rotationally fast connection between the two pins. Instead of providing coupling by the driver element 15, a textural polymer or an ionic electroactive polymer can be attached to the two mutually facing end faces of the pins and 13, or only on one of the two surfaces, the two surfaces cooperating to provide a frictional engagement upon application of an activation voltage so as to again ensure coupling of the pin 12 with the pin 13.

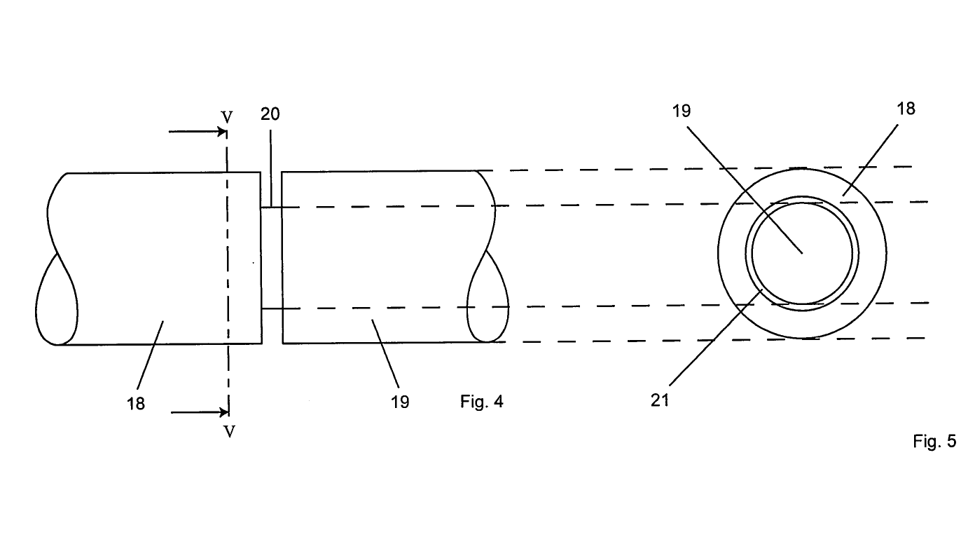

In a configuration according to FIGS. 4 and 5, with FIG. 4 being a side view and FIG. 5 a cross-sectional view, two pins 18 and 19 are again provided, pin 18 being connected with an actuating member such as a knob and pin 19 being connected with a locking device such as a locking lug. In this case, the pin 19 comprises a portion 20 of reduced cross section, which is immersed in an axial recess of the pin 18. Contrary to the configuration according to FIG. 3, the attachment of the textural polymer, or the ionic electroactive polymer, is not effected on the end faces, but on the mutually facing outer and inner peripheral surfaces of the pins 18 and 19. In the non-activated state, a gap 21 is maintained between the inner periphery of the pin 18 and the outer periphery of the offset portion 20 of the pin 19. When applying the activation voltage, the textural polymer or the ionic electroactive polymer will change in such a manner as to cause a frictional engagement between the inner shell of the pin 18 and the outer shell of the offset portion 20 of the pin 19, thus causing the actuating element connected with the pin 18 to be coupled with the locking member connected with the pin 19.

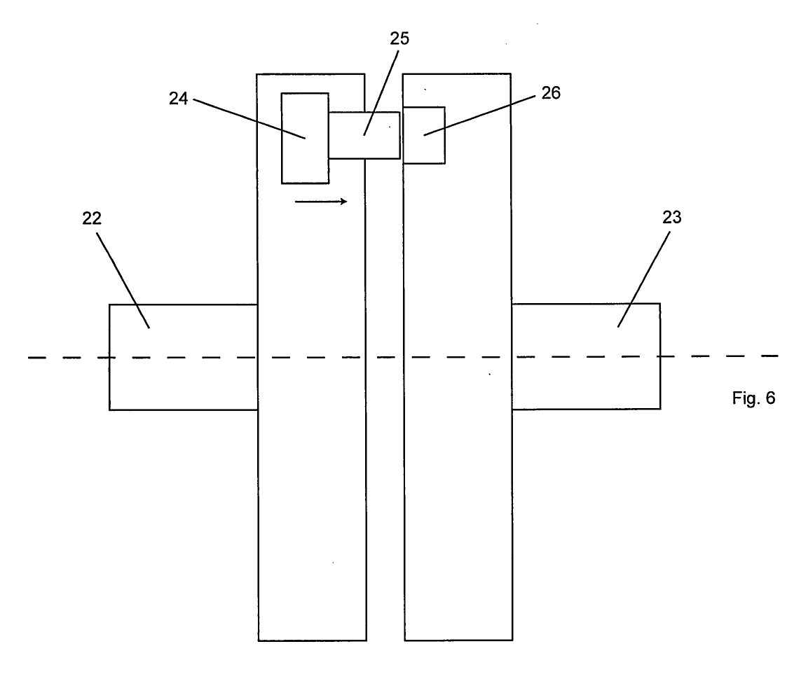

The modified configuration of the coupling device illustrated in FIG. 6 is particularly suitable for incorporation in an armature, lock rosette and mortise lock. Part 22, which is illustrated on the left-hand side of FIG. 6, is connected with the actuating element such as, for instance, a latch of the armature, and part 23, which is illustrated in the drawing on the right-hand side, is connected with the locking device such as, for instance, a lock striker-plate actuator. An actuator 24 made of an electroactive polymer and capable of moving a driver element such as a steel pin 25 between a disengagement position and an engagement position is again provided to enable the steel pin 25 to be immersed in the recess 26 for coupling the actuating element with the locking device.

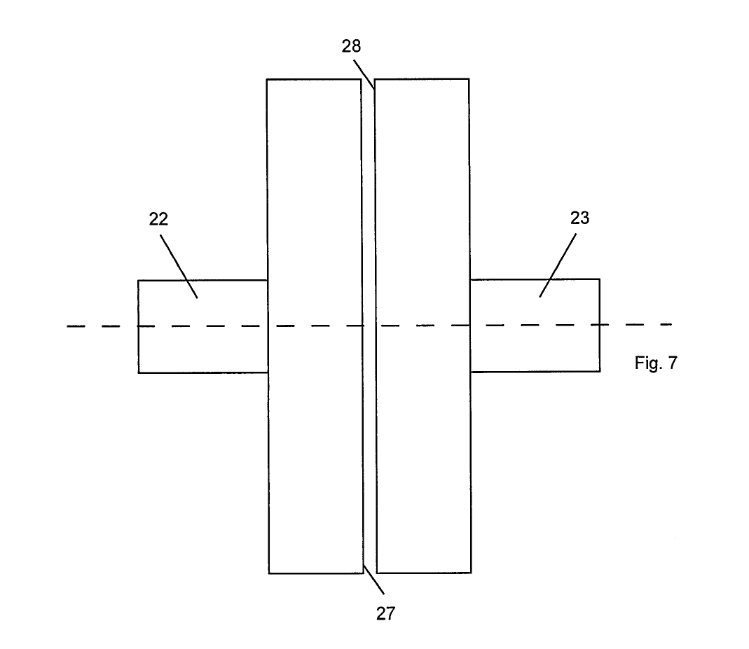

In the configuration according to FIG. 7, as compared to the configuration according to FIG. 6, a textural polymer or an ionic electroactive polymer is provided on the mutually facing surfaces 27 and 28 such that a frictional engagement will be formed between the parts 22 and 23 at a suitable activation. If required, the mutually facing surfaces 27 and 28 may have special surface structures in order to ensure an improved force transmission.

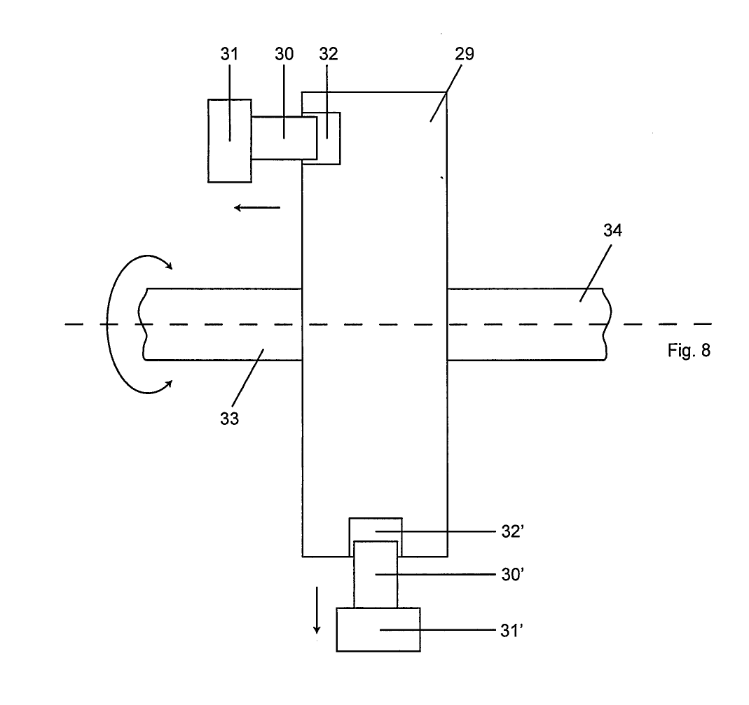

FIG. 8 depicts a modification of the configuration according to FIGS. 6 and 7, the actuation of the locking device in this case being prevented by the component 29 being blocked in its rotational movement after the driver element 30 has been displaced into a recess 32 by the actuator 31. Instead of the axially displaceable driver element 30, a radially adjustable driver element 30′ may be provided, which can be displaced into a radial recess 32′ by an actuator 31′ in order to block the rotation of the component 29. The component 29 in this case, on the one hand, is connected with a pin 33 leading to the actuating element and, on the other hand, is connected with a pin 34 leading, for instance, to the lock striker-plate actuator.

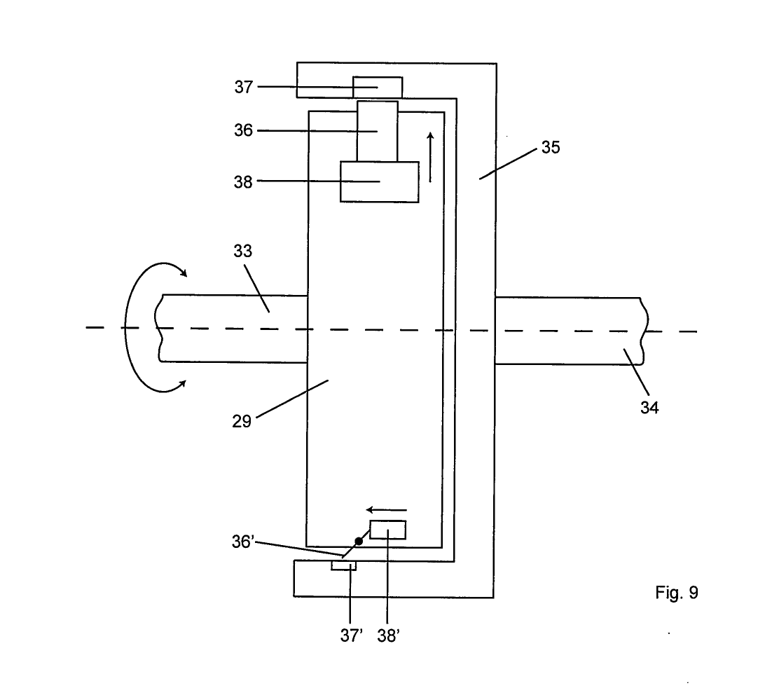

A similar configuration is illustrated in FIG. 9, wherein the same reference numerals are again used for identical parts. As opposed to the configuration according to FIG. 8, a fork-like or cylindrical component 35 encompassing the component 29 is provided between the pins 33 and 34 beside the component 29 so as to principally enable the pins 33 and 34 to be rotated relative to each other. Coupling is again effected by the driver element 36 being displaced into a recess 37 by the aid of the actuator 38. Alternatively to the positive engagement, a textural polymer or an ionic electroactive polymer may be arranged on the mutually facing surfaces of the components 29 or 35 so as to enable the generation of a frictional engagement upon activation of said polymer. A driver element which is pivoted about an axis into a recess 37′ by an actuator 38′ is denoted by 36′.

To sum up, it is apparent that a plurality of arrangements in which the use of electroactive polymers in locking-engineering products is feasible and conceivable may be envisaged, wherein reliable releasing and/or reliable locking of the lock is enabled in any case.

1. A device for locking a lock, comprising an actuating member to be coupled with a locking device via an interposed coupling device, said coupling device comprising
a driver element and
an actuator made of an electroactive polymer, wherein
the driver element is movable between an engagement position and a disengagement position by the aid of the actuator.

2. A device according to claim 1, wherein the actuator changes in dimension upon application of an electric voltage.

3. A device according to claim 1, wherein the actuator bends or arches upon application of an electric voltage.

4. A device according to claim 1, wherein the driver element is translationally guided.

5. A device according to claim 4, wherein the driver element is translationally guided in a direction parallel with the an axis of rotation of the actuating member.

6. A device according to claim 1, wherein the driver element is pivotally mounted.

7. A device according to claim 1, wherein the driver element is formed by a surface of an electroactive textural polymer or ionic electroactive polymer.

8. A device according to claim 1, wherein the actuating member is designed as a turning knob.

9. A device according to claim 1, wherein the actuating member comprises a motor.

10. A device according to claim 2, wherein the driver element is translationally guided.

11. A device according to claim 3, wherein the driver element is translationally guided.

12. A device according to claim 2, wherein the driver element is pivotally mounted.

13. A device according to claim 3, wherein the driver element is pivotally mounted.

14. A device according to claim 2, wherein the actuating member is a turning knob.

15. A device according to claim 3, wherein the actuating member is a turning knob.

16. A device according to claim 4, wherein the actuating member is a turning knob.

17. A device according to claim 5, wherein the actuating member is a turning knob.

18. A device according to claim 2, wherein the actuating member comprises a motor.

19. A device according to claim 3, wherein the actuating member comprises a motor.

20. A device according to claim 4, wherein the actuating member comprises a motor.
